(19) United States
(12) Patent Application Publication
(10) Pub. No.: US 2017/0021661 A1
(43) Pub. Date: Jan. 26, 2017

(54) FACT SHEET INTENDED FOR BEING INSERTED BETWEEN TWO PAGES OF A STATIONERY PRODUCT, SUCH AS A NOTEBOOK

(71) Applicant: HOLDHAM, Herouville-Saint-Clair (FR)

(72) Inventor: Paul Mario Pelucchi, Bayeux (FR)

(21) Appl. No.: 15/113,519

(22) PCT Filed: Feb. 2, 2015
(86) PCT No.: PCT/FR2015/050235

§ 371 Date: Jul. 22, 2016

(30) Foreign Application Priority Data
Feb. 3, 2014 (FR) 14 50 820

(51) Int. Cl. B42F 3/06; B42D 15/00; B42F 3/00; B42B 5/12

(52) U.S. Cl. CPC B42F 3/06; B42B 5/12; B42D 15/0006; B42F 3/006

(57) ABSTRACT

A fact sheet for insertion between two pages of a notebook, the notebook pages being bound by a spiral binding. The fact sheet includes a sheet having two generally parallel sides and, along one of the sides, a row of perforations into which the coils of the binding can be inserted to removably secure the sheet to the coils. The row of perforations includes a uniform alternation of oblong perforations and narrower perforations that are narrower than the oblong perforations. The alternation has a period including an oblong perforation and a narrower perforation, which are adjacent and consecutive. Each oblong perforation is shaped to receive either one coil or two coils, depending on the separation of the coils of the stationery product, and each narrow perforation is shaped to receive a single coil.

### FIELD OF THE INVENTION

The present invention relates to a fact sheet, intended for being inserted between two pages of a stationery product, such as a notebook.

More particularly, the invention relates to such a fact sheet suitable for a product in which the pages are assembled together by a spiral binding. Such bindings are often called “wire comb binding” or “wire-O”. More particularly, the invention relates to such a fact sheet comprising, along one of its sides, a row of perforations in which the coils of the binding can be inserted to removably retain the sheet in the coils.

### BACKGROUND

Sheets with rows of perforations are known from document FR 2,943,948. This document FR 2,943,948 describes a solution with removable sheets to be fastened to sheet binding coils of a notebook. The sheets are adapted to a single type of spiral binding to attach removably between two sheets of the notebook. Yet it has proven practical to be able to use identical sheets in different predetermined spiral notebooks.

### SUMMARY OF THE INVENTION

The present invention in particular aims to resolve the drawbacks of the prior art by proposing an improved solution.

To that end, the invention relates to a fact sheet, intended for being inserted between two pages of a stationery product, such as a notebook, said pages being assembled together by a spiral binding. The sheet includes, along one of the sides thereof, a row of perforations into which the coils of the binding can be inserted so as to removably secure the sheet to the coils. The row of perforations comprises a regular alternation of oblong perforations and perforations that are narrower than the oblong perforations, the alternation periodically comprising an oblong perforation and a narrower perforation, which are adjacent and consecutive. Each oblong perforation is shaped so as to receive either one coil or two coils depending on the separation of the coils of the stationery product, and each narrow perforation is shaped so as to receive a single coil.

In various embodiments of the sheet according to the invention, it is optionally possible to use one and/or another of the following provisions:

each perforation comprises a coil receiving orifice and an elastically deformable coil passage neck to engage or disengage the sheet with respect to the binding, the width of each neck being smaller than the longitudinal dimension of the corresponding orifice and the passage neck for the oblong perforations being wider than the neck of the narrower perforations;

each neck is defined by two lips opposite one another, the lips being elastically deformable to deform during the insertion and removal of the coils of the binding through the neck so as to respectively house them in or remove them from the orifices;

the oblong perforations on the one hand and the narrower perforations on the other hand are periodically separated by substantially 25.4 millimeters to correspond the periodic separation of the coils of the binding, which has two coils per period of substantially 25.4 millimeters or three coils per period of substantially 25.4 millimeters;

the orifices of the narrower perforations have a circular contour and the oblong orifices have circular end contours, with a straight contour bottom and with a spiral passage neck opposite the straight bottom contours;

the sheet has a grammage comprised between 150 grams and 250 grams per square meter;

the sheet is made from paperboard, plastic laminated paper or a polymer material;

the sheet can be used as an insert.

Furthermore, the invention also relates to a stationery product with pages bound to one another by a spiral binding, such as a notebook, and which is characterized in that it comprises at least one sheet according to the invention and that can be removably fastened to the coils of the binding in any chosen location between two pages of the stationery product.

Furthermore, the invention also relates to a sheet reserve notebook comprising a spiral binding and sheets according to the invention to be able to be detached from said spiral and used in a stationery product according to the invention.

### BRIEF DESCRIPTION OF DRAWING FIGURES

Other aims, features and advantages of the invention will appear over the following description of one of its embodiments and an alternative, given as non-limiting examples, in light of the attached drawings.

In the drawings:

FIG. 1 is a diagrammatic perspective top view of an open notebook comprising an annotation sheet according to the invention, this figure making it possible to illustrate the usage context of such a sheet;

FIG. 2 is a top view of an annotation sheet according to the invention, separated from the notebook;

FIG. 3 is an enlarged view showing part of the sheet of FIG. 2, to better show the perforation dimensions of the sheet;

FIG. 4 is a top view of the sheet according to the invention, attached on first coils of a first notebook having a first type of spiral;

FIG. 5 is an enlarged view showing part of the sheet and coils of FIG. 4, to better show the attachment of the sheet on the first coils;

FIG. 6 is a top view of the sheet according to the invention, attached on second coils of a second notebook having a second type of spiral;

FIG. 7 is an enlarged view of the sheet and coils of FIG. 7, to better show the attachment of the sheet on the second coils;

FIG. 8 is a view according to FIG. 1 for a sheet with larger dimensions.

### DETAILED DESCRIPTION

The present invention relates to the field of stationery products of the type with pages bound to one another by a spiral binding, for example notebooks for academic or professional use, notepads or the like. Such a spiral binding is often called “wire comb binding” or “wire-O”.

The invention will be described as it applies to a notebook for academic or professional use, but it may of course apply to any other type of similar stationery product.

The user of such a product is often required, during work, to enter important information aside from that noted on one or more sheets of the stationery product and that may or may not be related to the work noted on each corresponding page of the stationery product.

The known use of loose leaf sheets of the Bristol type makes it possible to note precious information that one does not wish to lose, such as urgent appointments, a to-do list, contact information for individuals, creative ideas or bibliographical notes, or to keep permanent information that is frequently used, such as lists of telephone numbers or a schedule.

However, such loose leaf sheets have the drawback of being easily lost, even if they are slipped between two pages of the stationery product.

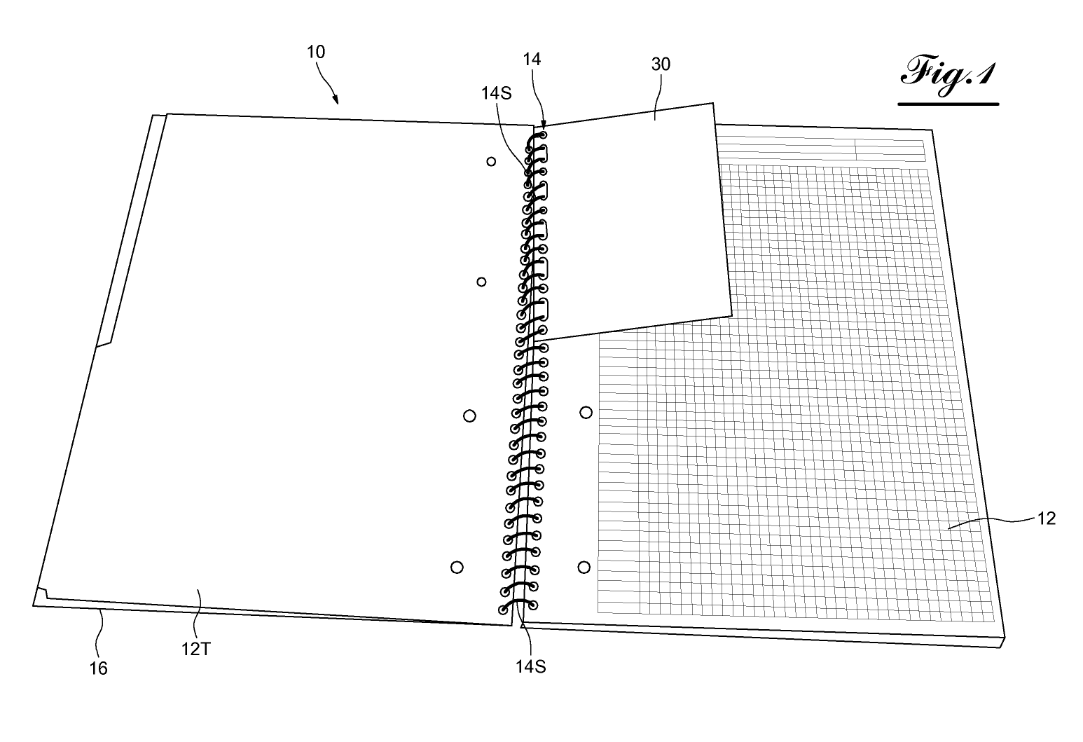

In reference to the figures, reference 10 designates a notebook whereof the pages 12 are bound to one another by a spiral binding 14. In FIG. 1, the coils 14S are parallel rings traversing the perforations of the pages 12, each coil having a single wire. This depiction makes it possible to clarify the drawing. Each coil 14S can be made up of two twinned ring-shaped wires, as in the case of the illustrations of FIGS. 4 to 7, in which the coils are shown in a sectional view.

In addition to the pages 12, the notebook 10 may include one or several sheets forming inserts 12T inseparably secured to the binding 14. Of course, the set of pages 12 and insert sheets 12T is arranged between two cover elements 16 of the notebook.

The notebook 10 comprises at least one sheet 30 able to be removably fastened to the coils 14S of the binding 14 in any chosen location between two pages 12 of the notebook 10 or between the front cover element and the first page or between the last page and the back cover element of that notebook.

Each sheet 30 is made from a material, for example paperboard of the Bristol type, allowing information to be written by hand and/or printed from a laser or inkjet printer. The sheet 30 can be made from a material other than plastic laminated paper or a polymer-based material.

This information may consist of important notes, one or more telephone numbers, or any other type of information that absolutely must be kept in connection with the work done on a corresponding one of the pages 12 of the notebook 10.

Thus, each sheet 30 can be separated from the binding 14 for the handwritten inscription of any useful information or to print such information on that page from a printer. In the latter case, the information may consist of printed graphics for example relative to the evolution in the price of items or goods related to the work done on one or more of the pages of the notebook or in drawings.

Once the information is inscribed on the sheet 30, the latter is repositioned in the notebook on top of the appropriate page 12 by fastening it to the coils 14S of the binding 14 in a chosen location along the binding. However, such information may be inscribed by hand on the sheet 30 remaining attached to the binding.

If several sheets 30 are used, they may be positioned with their information inscribed on them in any appropriate location between two pages 12 of the notebook 10 and by fastening them to the binding 14 in a chosen location along the latter.

The information that may also be inscribed on each sheet 30 includes extremely important or precious so-called “asides” that must not be mixed with the other notes on the pages 12 of the notebook and requiring special handling, for example tasks to be performed, client contact information, creative new ideas, bibliographical notes or any other type of information that must not be lost. Each sheet 30 including this information can be fastened to the binding on the first blank page 12 of the notebook so that it is immediately visible and not forgotten. For sheets including permanent information, such as lists of telephone numbers, addresses, rates, schedules or tables, the latter may be bound to the binding at the beginning or end of the notebook or on the first blank page of the latter so as to be easily relocated.

Each coil 14S is either formed by a wire wound as diagrammatically shown in FIG. 1 and FIG. 8, or formed by two segments of adjacent wires, as shown in some of the figures, in the case at hand FIGS. 4 to 7. The spiral notebook binding technology is of the traditional type and does not require further explanation.

Each sheet 30 comprises, along one of its sides, in the case at hand the left side, a series of perforations 33 in which the coils 14S of the binding 14 can be inserted to removably retain the sheet 30 in the coils 14S. The perforations emerge in an outer edge 30A of the sheet 30. The direction of this edge 30A, like the direction of the alignment of the perforations 33, determine the direction defined as longitudinal of the sheet.

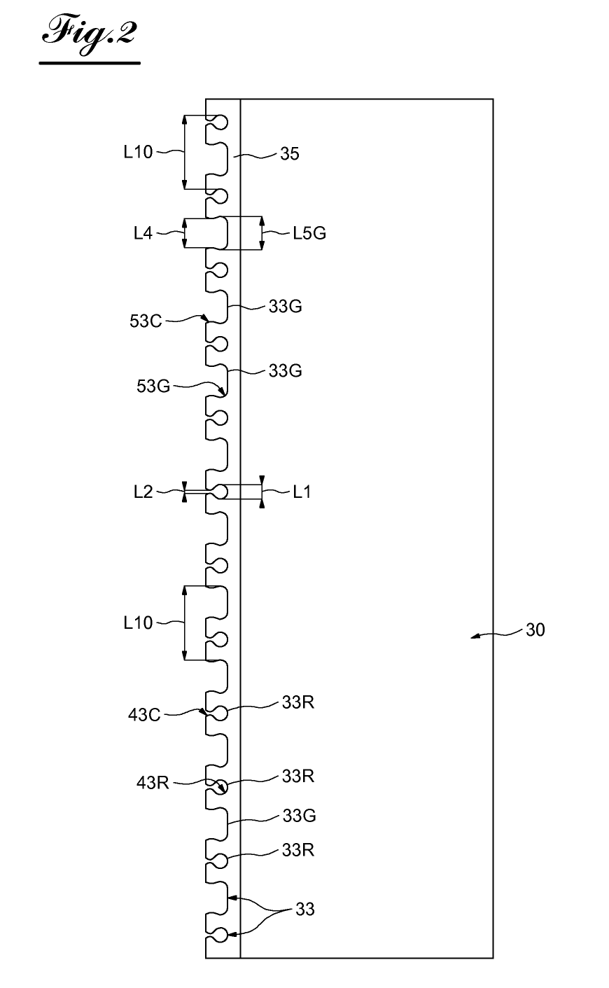

Because each sheet 30 is made from a material that may tear, it is preferable to reinforce the perforations 33 with a longitudinal reinforcing strip 35 that may be made from a plastic material and that is glued along the entire left side of the sheet 30 over a determined width from the outer edge 30A of the sheet 30. The reinforcing strip 35 is of course precut according to the perforations 33 on the side of the sheet 30. Furthermore, the reinforcing strip 35 is preferably made from a transparent material, although a strip 35 with a specific color is possible. The reinforcing strip 35 is shown diagrammatically in FIG. 2 only.

The perforations 33 of each sheet 30 have a separation from one another that must correspond to the pitch of the coils 14S of the binding 14. Advantageously, the perforations 33 of each sheet 30 are specific to adapt to different pitches of different types of bindings 14 of different notebooks. Each perforation 33 generally comprises a coil receiving orifice and a deformable coil passage neck for passage during the engagement or disengagement of the sheet relative to a binding. The neck is elastically deformable. The width of each neck is smaller than the longitudinal dimension of the corresponding orifice.

Each neck is generally defined by two lips opposite one another, which are elastically deformable in particular owing to the elasticity procured by the plastic reinforcing strip 35 during the insertion of a coil ring 14S of the binding 14 through the neck to house it in the corresponding orifice. Of course, the width between two lips of the neck is smaller than the width of the corresponding orifice.

The perforations 33 are specific while being arranged in a row having a regular alternation of round orifices 33R and oblong orifices 33G, each oblong orifice 33G being configured to receive either one coil 14S or two coils 14S depending on the separating pitch of the coils of the notebook making up the stationery product to which each sheet may adapt. As for example shown by FIG. 2, each circular perforation 33R is adjacent to an oblong perforation 33G. The passage next to the oblong perforations is wider than the neck of the narrower perforations with a round orifice.

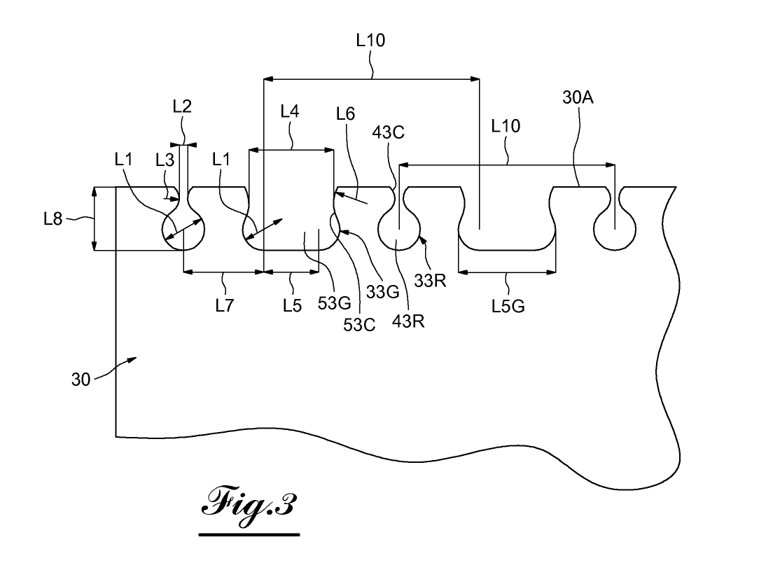

Each round perforation 33R comprises a circular orifice 43R able to surround the coil ring 14S and a narrow neck 43C communicating with the circular orifice 43R and emerging at the outer edge 30A of the sheet. In the illustrated embodiment, the diameter corresponding to the width L1 of each circular orifice is 5 millimeters (FIG. 3). The coil passage width L2 in the narrow neck 43C is 1 millimeter. The narrow neck 43C is made up of two arcs of circle with radius L3 connected on the one hand tangentially to the contour of the circular orifice 43R and on the other hand to the outer edge 30A of the sheet. The radius L3 of the neck arc here is 1.8 millimeters.

Each oblong perforation 33G comprises an oblong orifice 53G able to house at least one coil 14S and a wide neck 53C communicating with the oblong orifice 53G and emerging at the outer edge 30A of the sheet. In the illustrated embodiment, the coil passage width L4 in the wide neck 53C is 10 millimeters (FIG. 3). The ends of each oblong orifice 53G are circle portions with diameter L1, connected to a flat bottom with length L5. This length L5 also corresponds to the spacing of the two centers of the circle portions of the ends of the oblong orifice. This length L5 is equal to 6.5 millimeters. The largest longitudinal dimension L5G of the oblong orifices 53G is equal to 11.5 millimeters. Each wide neck 43C is formed by two arcs of circle with radius L6 connected on the one hand tangentially to the circled portions of the ends of the oblong orifice and on the other hand to the outer edge 30A. The radius L6 here is 4 millimeters.

A distance L7 separates the center of each circular orifice 43R from the closest center of the circle portions of the ends of the oblong orifice. This distance L7 is equal to 9.5 millimeters. A distance L8 separates the bottom of the perforations relative to the outer edge 30A. This distance L8 is equal to 7.5 millimeters.

A spacing pitch L10 of the circular orifices 43R is substantially equal to 25.4 millimeters, to correspond to an inch, which serves as the reference unit for notebook spirals. This separating pitch L10 is also that present between the oblong orifices 53G.

In light of the sizing of the perforations and their separating pitch with a regular alternation of round perforations 33R and oblong perforations 33G, the sheet 30 is universal for several types of spirals.

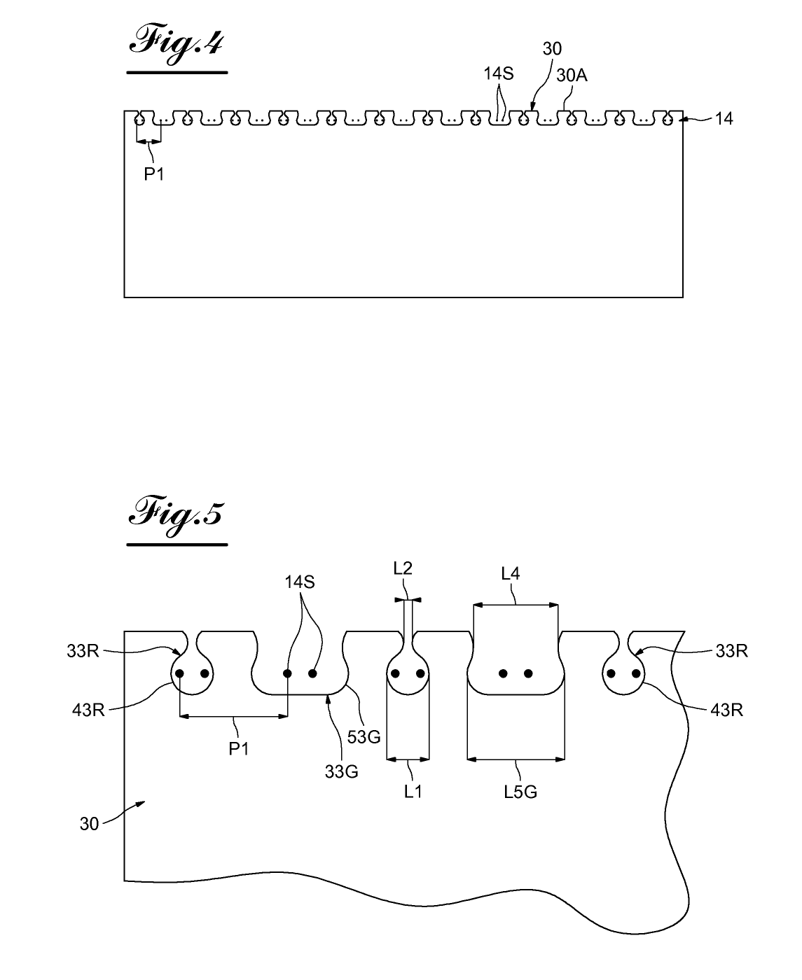

A first type of spiral is visible while being shown diagrammatically in FIGS. 4 and 5. For this first spiral type, the coils 14S each have two rings and are separated by a first pitch P1 corresponding to a pitch of two coils per inch. In this case, this therefore involves a spiral with two coils per 25.4 millimeter period.

This first type of spiral is commonly used in notebooks. In this case, the coils 14S have a relatively large spacing and, in alternation, a coil 14S is substantially at the center of a round perforation 33R circular orifice 43R, which is narrow, and an adjacent coil is substantially at the center of an oblong perforation 33G oblong orifice 53G, which is wide.

To fasten each sheet 30 to the first coils 14S of the binding 14, it suffices to press the lips of the narrow necks 43C against every other coil 14S of the binding 14 to cause them to penetrate to the circular orifices 43R, which then encircle the rings of the coils 14S after the lips of the neck have closed by their elasticity. Furthermore, during the pressing of the lips of the narrow necks 43C, the lips of the side necks 53C are traversed with play by the other coils 14S of the binding. Ultimately, half of the coils 14S of the first type are retained by attachment to the sheet 30, i.e., the coils engaged in the round perforations 33R, the other half of the coils being received with play in the oblong perforations 33G of the sheet.

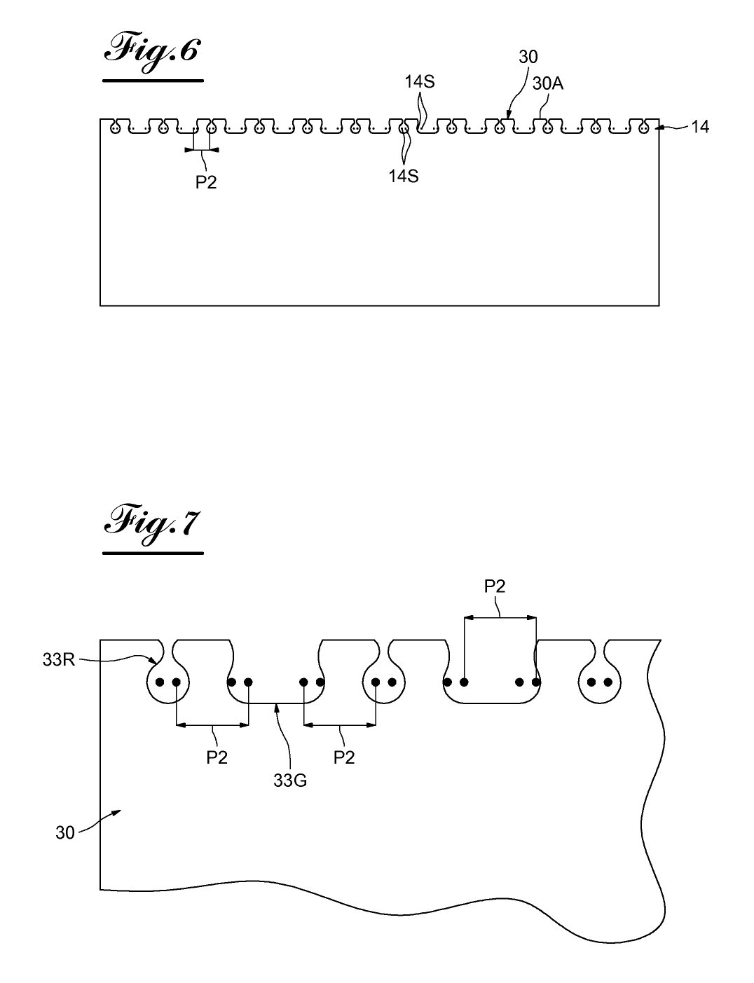

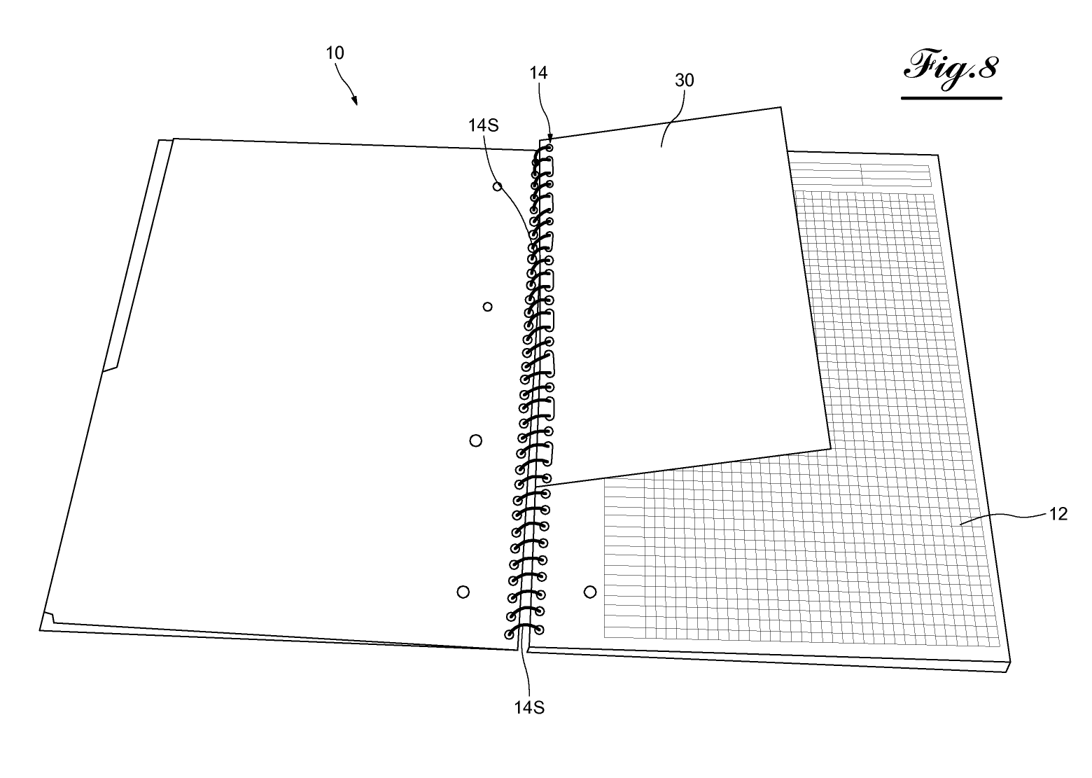

A second type of spiral is visible while being shown diagrammatically in FIGS. 6 and 7. For this second type of spiral, the coils 14S each have two rings and are spaced apart by a second pitch P2 corresponding to a pitch of three coils per inch. In this case, this therefore involves a spiral with three coils per 25.4 millimeter period.

This second type of spiral is also commonly used in notebooks. In this case, the coils 14S have a relatively small spacing. In alternation, one coil 14S is substantially at the center of a round perforation 33R circular orifice 43R, which is narrow, and, in an adjacent oblong orifice 53G, two consecutive coils are substantially at the ends of said oblong perforation 33G oblong orifice 53G, which is wide.

To fasten each sheet 30 to the binding 14, it suffices to press the lips of the narrow necks 43C and the lips of the wide necks 53C against the coils 14S of the second type of the binding 14 to cause them to penetrate to the circular orifices 43R and up to the oblong orifices 53G that then encircle the rings of the coils 14S after the lips of the necks have closed due to their elasticity. Ultimately, all of the coils 14S of the binding are retained by attachment to the sheet 30, one coil 14S out of every three being engaged in the round perforations 33R, the other two coils of the trio being engaged in the oblong perforations 33G of the sheet.

As shown by FIG. 1 and FIG. 8, each sheet 30 may have a determined format. According to FIG. 1, the sheet 30 has an A6-type format, while it has an A5 format in FIG. 8. In FIG. 2, FIG. 4 and FIG. 6, the sheets are shown in a longer format than the A5 or A6 format. The sheets could, in an alternative that is not shown, be in the A4 format. Furthermore, each sheet 30 may have printed lines.

Advantageously, the longitudinal dimension L5G of the oblong orifices 53G is such that a pair of coils can be housed in each oblong perforation 33G, an adjacent coil then being in a round perforation 33R. In cases with a spiral of the first type and second type with two coils per inch or three coils per inch, the lips of the necks of the perforations allow the removable attachment of the perforated sheet on the coils of the notebook. The rounded contours of the lips facilitate the insertion and removal of the sheets relative to the spiral of the notebook.

In the embodiments previously described and shown, the perforations have round lateral portions and arc-of-circle lips, but in alternatives that are not shown, the perforations may have contours with straight portions connected along corners. For example, the circle portions may be replaced by hexagon or ellipse portions.

In order to be particularly easy to use, each sheet 30 may have a grammage comprised between 150 grams per square meter and 250 grams per square meter, synonymous with a sheet made from a quality material giving value to the information written or printed on the sheet.

It should also be noted that each sheet 30 may be used as an insert to divide the notebook 10 into several parts in order to mark the corresponding page 12. In this case, each sheet 30 will be fastened to the binding 14 in a determined location along the latter, such that part of the sheet 30 may or may not overhang the upper or lower edge of the corresponding page 12 of the notebook 10. Thus, the insert sheets 30 may be customized and moved at will in the notebook to be repositioned therein.

When the sheet 30 has a format identical to the format of a page 12 of the notebook 10, the sheet 30 may include a colored strip, for example orange, on the right side opposite the left side including the perforations 33 to indicate the location of the sheet 30 in a notebook with white sheets. This strip may overhang the associated page 12 of the notebook.

Preferably, each sheet 30 is white, but may have other colors inasmuch as the information recorded thereon is readable.

The repositionable sheets 30 of the invention allow a user to keep important information, to carry it with the notebook in an appropriate location therein without risk of loss and without needing to use paperclips or another accessory to attach the sheet to a page of the notebook.

Furthermore, the sheets 30 with universal perforations can be marketed in a reserve sheet notebook. Thus, it suffices to detach sheets from the reserve sheet notebook to use them in a notebook 10 like that shown in FIG. 1, in which the sheet is attached. This reserve sheet notebook may indifferently have either a spiral of the first type with one [or] two coils per inch, or of the second type with three coils per inch. The sheets 30 with universal perforations can be marketed in a sheet assembly notebook, for example further including, at the beginning or the end of the packet of sheets of the notebook, sheets being able to be detached from the spiral binding to be used by being inserted between the sheets of the packet in the desired location.

1. A fact sheet for insertion between two pages of a stationery product, wherein the two pages are bound by a spiral binding with coils, the fact sheet comprising
a sheet having two generally parallel sides, and
along one of the sides, a row of perforations into which the coils of the binding can be inserted, removably securing the sheet to the coils, wherein
the row of perforations includes, in alternation, oblong perforations and narrower perforations that are narrower than the oblong perforations,
the alternation is periodic with oblong perforations and narrower perforations adjacent to each other, and consecutively arranged, and
each oblong perforation is shaped to receive either one coil or two coils, depending on the separation of the coils, and each narrower perforation is shaped to receive a single coil.

2. The fact sheet according to claim 1, wherein
each oblong and narrower perforation comprises a coil-receiving opening and an elastically deformable coil passage neck for engaging and disengaging the sheet with respect to the binding,
each passage neck has a width smaller than a longitudinal dimension of the corresponding opening, and
the passage necks for the oblong perforations are wider than the passage necks of the narrower perforations.

3. The fact sheet according to claim 2, wherein
each passage neck is defined by two lips that are opposite one another, and
the lips are elastically deformable for deformation during insertion and removal of the coils of the binding through the passage necks.

4. The fact sheet according to claim 1, wherein the oblong perforations and the narrower perforations are periodically separated by a distance substantially corresponding to periodic separation of the coils of the binding, and
the binding has two coils per period or three coils per period.

5. The fact sheet according to claim 2, wherein
the openings of the narrower perforations have a circular contour, and
the oblong perforations have circular end contours, a straight bottom contours, and a spiral passage neck opposite the straight bottom contours.

6. The fact sheet according to claim 1, wherein the sheet has a weight in a range from 150 grams per square meter to 250 grams per square meter.

7. The fact sheet according to claim 1, wherein the sheet is selected from the group consisting of paperboard, plastic laminated paper, and a polymer.

8. A stationery product with pages bound to one another by a spiral binding having coils, and at least one fact sheet according to claim 1 that can be removably fastened onto the coils of the binding in any location between two pages of the stationery product.

9-11. (canceled)
